(19) United States
(12) Patent Application Publication
(10) Pub. No.: US 2025/0388212 A1
(43) Pub. Date: Dec. 25, 2025

(54) Method for Operating a Lane Change Assistance System of a Vehicle Taking Into Account a Traffic Density in an Environment of the Vehicle, Lane Change Assistance System, and Vehicle

(71) Applicant: Bayerische Motoren Werke Aktiengesellschaft, Muenchen (DE)

(72) Inventors: Mortiz BLASCHE, Muenchen (DE); Michael GUTBROD, Muenchen (DE); Patrick SAUERMANN, Augsburg (DE); Kai STIENS, Muenchen (DE)

(21) Appl. No.: 18/879,615

(22) PCT Filed: Jun. 27, 2023
(86) PCT No.: PCT/EP2023/067394

§ 371 Date: Dec. 27, 2024

(30) Foreign Application Priority Data
Jun. 29, 2022 (DE) 10 2022 116 267.2

(51) Int. Cl. B60W 30/18

(52) U.S. Cl. CPC B60W 30/18163; B60W 2520/10; B60W 2540/223; B60W 2552/10; B60W 2554/4041; B60W 2554/4042; B60W 2554/4049; B60W 2554/406

(57) ABSTRACT

A method for operating a lane-change assistance system of a vehicle includes capturing ambient-field data that describe an environment of the vehicle. Further road-users are detected in the environment based on the ambient-field data. A route of a lane-change maneuver from an initial lane into a destination lane is planned, wherein lateral dynamics act on the vehicle during the lane-change maneuver. A traffic density describing a number, a distribution, and/or a motion of the further road-users in the environment is determined. The planned route of the lane-change maneuver is adapted as a function of the determined traffic density to vary the lateral dynamics during the lane-change maneuver.

### BACKGROUND AND SUMMARY

The present invention relates to a method for operating a lane-change assistance system of a vehicle. Furthermore, the present invention relates to a lane-change assistance system for a vehicle. Lastly, the present invention relates to a vehicle having such a lane-change assistance system.

Lane-change assistance systems for vehicles are sufficiently well-known from the prior art. In the known lane-change assistance systems with automated or automatic lane-change function, the driver typically indicates a desire to change lane by means of a certain operating action, for instance the actuating of the turn-signal lever. If such an operating action is detected, the vehicle is maneuvered along a planned trajectory into the adjacent lane, or into a destination lane, by means of the lane-change assistance system, with automatic lateral guidance and, in general, also with automatic longitudinal guidance. This results in lateral dynamics acting on the vehicle and consequently on the occupants of the vehicle during the lane-change maneuver.

The objective of the current design of lane-change assistance systems is, above all, to be able to offer—within the bounds of lawful possibilities—changes of lane also under more dynamic conditions, and to carry them out successfully. For instance, all lane-change maneuvers can be planned in such a manner that the same lateral dynamics act on the vehicle during the lane-change maneuver. The only variation with regard to dynamics comes about via the speed of the ego vehicle.

Furthermore, it is known from the prior art that driver-assistance systems can be adapted to a driving style of a driver. In this context, DE 10 2017 208 583 A1, for instance, describes a driving system for a vehicle that has been set up to guide the vehicle automatically, at least partially and/or intermittently, with a certain driving style. The driving style of the vehicle that is guided in automated manner can be adapted automatically as a function of sensor data relating to its occupants. For instance, the route of a trajectory can be adapted to a longitudinal acceleration and/or lateral acceleration.

Furthermore, complex methods for evaluating gaps between further road-users in the destination lane are additionally known from the prior art. These methods for gap evaluation serve, for instance, for decision-making as regards whether or not a change of lane can be carried out. A method of such a type is disclosed in DE 10 2015 203 208 A1, for instance.

The object of the present invention is to present a solution as to how a lane-change assistance system of the type mentioned in the introduction can be operated in a manner appropriate to the situation. In addition, a vehicle having a corresponding lane-change assistance system is to be made available.

In accordance with the invention, this object is achieved by means of a method, by means of a lane-change assistance system, and also by means of a vehicle, having various combinations of the features described herein.

A method according to the invention serves for operating a lane-change assistance system of a vehicle. The method includes the capturing of ambient-field data that describe an environment of the vehicle. Furthermore, the method includes the detecting of further road-users in the environment with the aid of the ambient-field data. In addition, the method includes the planning of a route of the lane-change maneuver from an initial lane into a destination lane, in the course of which certain lateral dynamics act on the vehicle during the lane-change maneuver. Furthermore, the method includes the determining of a traffic density in the environment, the traffic density describing a number, a distribution and/or a motion of the further road-users. The method further includes the adapting of the planned route of the lane-change maneuver for the purpose of preventing lateral dynamics during the lane-change maneuver, depending on the determined traffic density.

The lane-change assistance system may exhibit at least one ambient-field sensor, or distance sensor, by which the ambient-field data can be made available. These ambient-field data describe the environment, or ambient field, of the vehicle. In particular, on the basis of the ambient-field data the further road-users in the environment of the vehicle can be detected. The relative position of the further road-users with respect to the vehicle can preferably be determined.

By means of the lane-change assistance system, the lane-change maneuver from the initial lane, in which the vehicle is currently located, into the destination lane, or into the adjoining lane, can be planned. For instance, for this purpose an appropriate trajectory can be calculated, along which the vehicle is to be maneuvered. For the purpose of planning the lane-change maneuver, a check can be made as to whether or not there is a free gap for the vehicle between the further road-users in the destination lane. If a gap is detected, a check can be made as to whether this gap is suitable, with respect to its dimensions, for the lane-change maneuver.

The lane-change maneuver can then ordinarily be initiated, or started, after the capturing of a predetermined operating action, for instance after the actuating of the turn-signal lever by the driver. In addition, there may be provision that the lane-change maneuver is started automatically or in automated manner by means of the lane-change assistance system. If a suitable free gap between the further road-users in the destination lane is detected, the vehicle can be maneuvered into the destination lane, or into the adjoining lane, in at least partially automated manner by means of the lane-change assistance system. In this connection, an intervention in the steering of the vehicle may be effected—to be more exact, the lateral guidance may be taken over—by the lane-change assistance system. There is preferably provision, in addition, that the longitudinal guidance of the vehicle is also taken over by means of the driver-assistance system in the course of the automatic lane-change maneuver.

In the course of the implementation of the lane-change maneuver, lateral dynamics arise which act on the vehicle and consequently also on the occupants of the vehicle. The lateral dynamics may arise as a result of the planned trajectory along which the vehicle is maneuvered from the initial lane into the destination lane. The lateral dynamics may describe the lateral acceleration, the lateral jerk, the alteration of the steering-angle, or such like. The lateral dynamics may, in addition, be dependent on the current longitudinal speed of the vehicle. Depending on the lateral dynamics in the course of the lane-change maneuver, a corresponding perception with respect to the lateral dynamics arises for the driver, or for the occupants, of the vehicle.

It is known from the prior art that the respective lane-change maneuvers are carried out, or planned, with the same lateral dynamics. It is consequently to be ensured that a change of lane can be carried out successfully also under dynamic conditions. However, this may have the consequence—for instance in the case of a completely clear drive, in the course of which no further road-user is located in the destination lane—that in some cases the lane-change maneuver is perceived to be too dynamic for the occupants.

According to the present invention, there is now provision that a current traffic density in the environment of the vehicle is determined on the basis of the ambient-field data. This traffic density may, on the one hand, describe the number of road-users that are located in the environment of the vehicle. Furthermore, the traffic density may describe a distribution of the road-users. For instance, the traffic density may describe how many of the further road-users are located in the destination lane, in the initial lane and/or, where appropriate, in further available lanes. There may be provision, furthermore, that the traffic density describes the motion of the further road-users. In particular, the traffic density may describe the speed of the further road-users, which is determined on the basis of the ambient-field data.

Moreover, according to the present invention there is provision that the planned route of the lane-change maneuver is adapted as a function of the determined traffic density. By virtue of the adapting of the lane-change maneuver, a variation of the lateral dynamics during the lane-change maneuver can be obtained. In particular, a trajectory along which the vehicle is maneuvered from the initial lane into the destination lane can be adapted. In this connection, the current longitudinal speed of the vehicle can be taken into account.

The finding underlying the present invention is that in differing traffic situations the lateral dynamics perceived as being comfortable may vary greatly during the lane-change maneuver. With the method according to the invention, a variation in the dynamics can be introduced across differing traffic situations, so that lane-change maneuvers that are carried out are perceived at all times to be comfortable, safe, and appropriate to the situation. Consequently, it can be ensured that the dynamics during the automated change of lane are varied and adapted, depending upon the traffic situation, in such a manner that by this means the maximum comfort is obtained and the natural flow of traffic is guaranteed.

The planned route of the lane-change maneuver is preferably adapted in such a manner that the lateral dynamics during the lane-change maneuver are increased with increasing traffic density. If, for instance, a lane-change maneuver is to be carried out, or is demanded by the driver, the current traffic density in the environment of the vehicle can be determined. On the basis of the determined traffic density, the subsequent lane-change maneuver can then be planned in a manner adapted to the situation. For instance, differing trajectories may have been stored for differing traffic densities, or differing traffic situations, which can then be selected accordingly, depending on the current speed. In addition, there may be provision that, depending upon the traffic density, maximum lateral dynamics are preset, on the basis of which the trajectory can then be planned. In other words, depending upon the traffic situation, or the traffic density, the trajectory can be planned in such a manner that the preset maximum lateral dynamics are not exceeded during the lane-change maneuver.

In principle, however, the lane-change maneuvers—to be more exact, the route of the lane-change maneuver—can be adapted in such a manner that in the case of a relatively high traffic density a lane-change maneuver with relatively high lateral dynamics is carried out. In contrast, in the case of a low traffic density the lane-change maneuver can be adapted in such a manner that low lateral dynamics arise. In this way, it can be ensured that the driver, and the further occupants, perceive the lane-change maneuver, carried out in automated manner, to be comfortable and safe in regard to the current traffic situation.

It is advantageous, furthermore, if in the course of the determining of the traffic density for the lane-change maneuver a dimension of a gap between the further road-users in the destination lane is determined, and the route of the planned lane-change maneuver is adapted as a function of the dimension of the gap. In the course of the determining of the traffic situation in the environment of the vehicle, firstly a check can be made as to whether there is a free gap in the destination lane. If such a free gap is present, the dimension of this gap can be determined.

In this connection, there is provision, in particular, that the dimension of the gap in the direction of travel—to be more exact, in the principal direction of extent of the destination lane—is determined. In other words, the length of the gap can therefore be determined. If this gap is sufficient for a lane-change maneuver with the vehicle, the trajectory—to be more exact, the route of the planned lane-change maneuver—can be adapted to the size of the gap. For instance, in the case of relatively large gaps the lateral dynamics can be reduced, in order to make possible a change of lane that is as comfortable as possible for the occupants of the vehicle. Conversely, in the case of smaller gaps the lateral dynamics can be increased, in order that the lane-change maneuver can be carried out safely.

In a further embodiment, in the course of the determining of the traffic density a speed of at least one further road-user that is delimiting a gap for the lane-change maneuver is determined, and the route of the planned lane-change maneuver is adapted as a function of the speed. In this connection, in particular the speed of the road-user that is approaching the gap from behind can be determined. This road-user can reduce, or close, the gap that is still currently present if it closes up—for instance, at an increased speed—on the traveling ahead, or on the further road-user delimiting the gap. This may occur in like manner if the road-user that is delimiting the gap ahead reduces its speed.

On the basis of the speeds of the respective road-users that are delimiting the gap, it can be ascertained whether a diminution of the dimensions of the gap is imminent. If such a closing of the gap is imminent, the lane-change maneuver can be planned in such a manner that it is carried out with relatively high lateral dynamics, in order to be able to carry out the lane-change maneuver safely. However, if a sufficiently large gap is present and, for instance, the road-users that are delimiting the gap do not vary their speed, or the rear road-user that is delimiting the gap reduces its speed, the lane-change maneuver can be carried out with low lateral dynamics.

In a further embodiment, the route of the planned lane-change maneuver is adapted for the purpose of obtaining minimal lateral dynamics during the lane-change maneuver if there is no further road-user in the destination lane within a predetermined distance from the vehicle. If, for instance, no further road-user in the destination lane can be detected within the detection zone of the at least one ambient-field sensor, the lane-change maneuver can be planned with minimal lateral dynamics. Consequently, the maximum comfort can be obtained during the lane-change maneuver.

There may, in addition, be provision that the presence of further road-users in the initial lane is checked. In particular, it can be checked whether a further road-user is located in the initial lane and ahead of the ego vehicle. Also in this case, the distance at which this further road-user is located from the vehicle can be checked. Furthermore, the speed of this further road-user in the destination lane, which is located ahead of the vehicle, can be checked. If, for instance, this road-user reduces its speed, the lane-change maneuver can be planned with higher lateral dynamics.

In addition, it can be checked whether a further road-user is present in a lane adjacent to the destination lane. The route of the planned lane-change maneuver can be adapted as a function of the presence of the further road-user in the lane adjacent to the destination lane. The lane adjacent to the destination lane may be arranged on the side of the destination lane situated opposite the initial lane. The lateral dynamics of the lane-change maneuver can be reduced if a further road-user is located in this lane adjacent to the destination lane, or in the lane next to that. This applies, in particular, to the case where the further road-user is located in the region of, or level with, the gap.

In addition, the lateral dynamics can be adapted as a function of the dimensions and/or distance of the further road-user in the lane adjacent to the destination lane. In the case of further road-users having large dimensions, for instance a truck, the lateral dynamics can be reduced. In this case, the driver, or the occupants, may become unsettled when they are moving toward such a road-user in the course of the lane-change maneuver. This applies in like manner if a further road-user is located very close to the destination lane or is even partially protruding into the destination lane. Also in these cases, relatively low lateral dynamics can be chosen for the lane-change maneuver.

In a further embodiment, a check is made as to whether a driver of the vehicle has his/her hands on the steering wheel, and the route of the planned lane-change maneuver is additionally determined as a function of whether or not the driver has his/her hands on the steering wheel. Depending on the design of the driver-assistance system, or of the lane-change assistance system, there may be provision that during the operation of the lane-change assistance system the driver has to put his/her hands on the steering wheel. In this case, the lane-change maneuver can be carried out with higher lateral dynamics. If the driver has his/her hands on the steering wheel, the stronger steering intervention by the driver-assistance system during the lane-change maneuver, for instance, may not be perceived by the driver to be disturbing. In the case of a so-called hands-off system, in which the driver may take his/her hands off the steering wheel at least in some cases, lower lateral dynamics can be chosen. If the driver does not currently have his/her hands on the steering wheel, he/she may not become unsettled by the comfortable lane-change maneuver.

The lane-change maneuver can be triggered or initiated as a function of a captured operating action of the driver, but it can also be triggered or initiated automatically without any operating action of the driver. If the lane-change maneuver is started as a consequence of the operating action of the driver, higher lateral dynamics can be chosen during the lane-change maneuver than in the case of a lane-change maneuver initiated automatically. If the driver has triggered the lane-change maneuver himself/herself by virtue of the operating action, he/she will expect that a change of lane will subsequently be carried out. However, if a change of lane is initiated automatically by the lane-change assistance system, the driver may possibly be surprised. This surprising of the driver can be reduced by means of low lateral dynamics in the course of the lane-change maneuver.

A lane-change assistance system, according to the invention, for a vehicle has been set up to capture ambient-field data that describe an environment of the vehicle. In addition, the lane-change assistance system has been set up to detect further road-users in the environment with the aid of the ambient-field data. In addition, the lane-change assistance system has been set up to plan a route of the lane-change maneuver from an initial lane into a destination lane, in the course of which certain lateral dynamics act on the vehicle during the lane-change maneuver. In addition, the lane-change assistance system has been set up to determine a traffic density in the environment, the traffic density describing a number, a distribution and/or a motion of the further road-users. Lastly, the lane-change assistance system has been set up to adapt the planned route of the lane-change maneuver as a function of the determined traffic density for the purpose of varying the lateral dynamics during the lane-change maneuver.

The lane-change assistance system may exhibit at least one ambient-field sensor which, for instance, may take the form of a camera, radar sensor, lidar sensor, or such like. In addition, the lane-change assistance system may exhibit a computing device which may be constituted by at least one electronic control unit, a processor, or such like. On the basis of the ambient-field data from the ambient-field sensor, the traffic density in the environment of the vehicle can be determined by means of the computing device.

In addition, by means of the computing device the lane-change maneuver can be planned—to be more exact, a trajectory for the maneuvering of the vehicle from the initial lane into the destination lane can be planned. In this connection, the computing device can adapt the trajectory as a function of the determined traffic density. In addition, the lane-change assistance system may exhibit a steering-wheel sensor, by means of which it can be ascertained whether or not the driver currently has his/her hands on the steering wheel. Depending on whether the driver has his/her hands on the steering wheel, the computing device can additionally adapt the trajectory—to be more exact, the route—of the lane-change maneuver.

In addition, the computing device may have been designed to output a control signal for activating a steering assembly or a steering system of the vehicle. As a result of the activation of the steering assembly, the lateral guidance of the vehicle can then be taken over in the course of the lane-change maneuver. There may, in addition, be provision that a longitudinal guidance of the vehicle is carried out by means of the lane-change assistance system during the lane-change maneuver.

A vehicle according to the invention includes a lane-change assistance system according to the invention. The vehicle takes the form, in particular, of a passenger car.

The preferred embodiments and the advantages thereof that have been presented with reference to the method according to the invention apply correspondingly to the lane-change assistance system according to the invention and also to the vehicle according to the invention.

Further features of the invention will become apparent from the claims, from the Figures, and from the description of the Figures. The features and combinations of features mentioned above in the description, as well as the features and combinations of features mentioned below in the description of the Figures and/or shown in the Figures alone are capable of being used not only in the respectively specified combination but also in other combinations or on their own, without departing from the scope of the invention.

The invention will now be described in further detail with with reference to the appended drawings.

### BRIEF DESCRIPTION OF THE DRAWINGS

FIG. 1 shows a schematic representation of a vehicle that exhibits a lane-change assistance system for carrying out an automatic lane-change maneuver;

FIG. 2 shows the vehicle in a first traffic situation prior to the implementation of a lane-change maneuver; and

FIG. 3 shows the vehicle in a second traffic situation prior to the implementation of a lane-change maneuver.

### DETAILED DESCRIPTION OF THE DRAWINGS

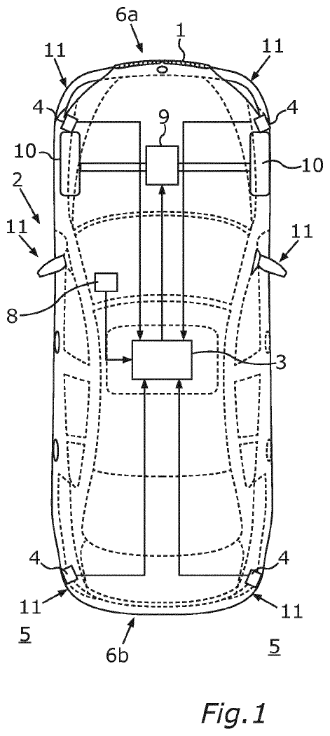

FIG. 1 shows a vehicle 1, which in the present case takes the form of a passenger car, in a plan view. The vehicle 1 includes a lane-change assistance system 2, by means of which automatic lane-change maneuvers with the vehicle 1 can be carried out. The lane-change assistance system 2 includes a computing device 3 which, for instance, may be constituted by at least one electronic control unit of the vehicle 1.

Furthermore, the lane-change assistance system 2 includes at least one ambient-field sensor 4. In the present example, the lane-change assistance system 2 includes four ambient-field sensors 4, of which two ambient-field sensors 4 are arranged in a front region 6a and two ambient-field sensors 4 are arranged in a rear region 6b. The ambient-field sensors 4 are arranged in the respective corners of the vehicle 1. The ambient-field sensors 4 may, for instance, take the form of radar sensors. With the ambient-field sensors 4, appropriate measurements can be carried out, and in this connection ambient-field data can be made available, in order to be able to detect further road-users 12 in an environment 5 of the vehicle 1.

The computing device 3 has further been set up to capture a predetermined operating action of a driver, carried out on an operating element 8. The operating element 8 may be, for instance, a turn-signal lever. As a consequence of the actuation of the operating element 8, direction indicators 11, which in the present case have been only hinted at, are activated. In addition, the computing device 3 can detect whether the driver currently has his/her hands on a steering wheel of the vehicle 1.

Furthermore, the computing device 3 has been set up to activate a steering system 9 of the vehicle 1, which in the present case has been represented only schematically. As a result of the activation of the steering system 9, the lateral guidance of the vehicle 1 can be carried out in the course of the lane-change maneuver. As a result of the activation of the steering system 9, steerable wheels 10 of the vehicle 1 can be steered, and consequently the lateral guidance can be taken over in the course of the lane-change maneuver.

The computing device 3 has, in addition, been set up to determine a traffic density in the environment 5 of the vehicle 1 on the basis of the ambient-field data from the ambient-field sensors 4. The traffic density may describe a number, a distribution and/or a motion of the further road-users 12.

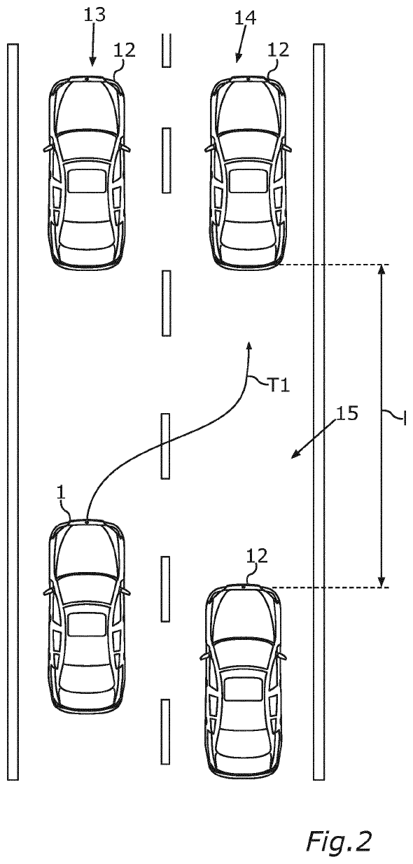

FIG. 2 shows the vehicle 1 in a first traffic situation.

The vehicle 1 is located in an initial lane 13. With the vehicle 1, a lane-change maneuver from the initial lane 13 into a destination lane 14 is to be carried out. Prior to the actual implementation of the lane-change maneuver, the route of the lane-change maneuver from the initial lane 13 into the destination lane 14 is planned by means of the lane-change assistance system 2—to be more exact, by means of the computing device 3. For this purpose, an appropriate trajectory T1, T2 is determined, along which the vehicle 1 is maneuvered from the initial lane 13 into the destination lane 14. There is provision that the route of the lane-change maneuver—to be more exact, the trajectory T1, T2—is adapted as a function of the traffic density.

In addition, the route—to be more exact, the trajectory T1, T2—can be adapted as a function of whether or not the driver currently has his/her hands on the steering wheel of the vehicle 1. If the driver has his/her hands on the steering wheel, higher lateral dynamics can be chosen than when the driver does not have his/her hands on the steering wheel.

In the example shown in FIG. 2, there is a high traffic density. In this case, a further road-user 12 is located in the initial lane 13 ahead of the vehicle 1 in the direction of travel. In the present schematic representation, two further road-users 12 that are delimiting a gap 15 are located in the destination lane 14. As a result of the planning of the trajectory T1, the lateral dynamics that act on the vehicle 1—to be more exact, on the occupants of the vehicle 1—during the lane-change maneuver are influenced. Given the present high traffic density, a first trajectory T1 is determined that results in relatively high lateral dynamics in the course of the lane-change maneuver. Given this high traffic density, it is to be ensured that the lane-change maneuver into the gap 15 can be carried out reliably.

In addition, dimensions of the gap can be determined and taken into account in the planning of the trajectory T1. In particular, the dimension of the gap 15 in the direction of travel—to be more exact, in the principal direction of extent of the destination lane 14; more precisely, a length 1—is determined. Alternatively or additionally, the respective speeds of the further road-users 12 that are delimiting the gap 15 can be determined. Alternatively or additionally, in particular the speed of the road-user 12 that is approaching the gap from behind can be determined. If this road-user 12 has an elevated speed, the gap may be closed. If this is imminent, the lateral dynamics in the course of the lane-change maneuver can be increased.

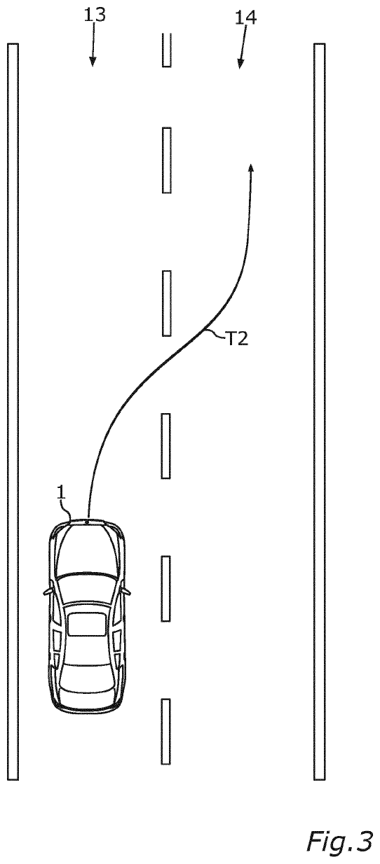

In comparison with this, FIG. 3 shows a schematic representation of the vehicle 1 according to a second traffic situation. In this traffic situation, no further road-users 15 are located in the initial lane 13 or in the destination lane 14. Therefore in this case a second trajectory T2 for the lane-change maneuver is determined. With this trajectory T2, lateral dynamics that act on the vehicle 1 arise that are as low as possible, or minimal. Hence a particularly comfortable lane-change maneuver can be made possible.

1-8. (canceled)

9. A method for operating a lane-change assistance system of a vehicle, comprising:
capturing ambient-field data that describe an environment of the vehicle;
detecting further road-users in the environment based on the ambient-field data;
planning a route of a lane-change maneuver from an initial lane into a destination lane, wherein lateral dynamics act on the vehicle during the lane-change maneuver;
determining a traffic density describing a number, a distribution, and/or a motion of the further road-users in the environment; and
adapting the planned route of the lane-change maneuver as a function of the determined traffic density to vary the lateral dynamics during the lane-change maneuver.

10. The method of claim 9, wherein the planned route of the lane-change maneuver is adapted in such a manner that the lateral dynamics during the lane-change maneuver are increased with increasing traffic density.

11. The method of claim 9, wherein, in the course of the determining of the traffic density for the lane-change maneuver, a dimension of a gap between the further road-users in the destination lane is determined, and the route of the planned lane-change maneuver is adapted as a function of the dimension of the gap.

12. The method of claim 9, wherein, in the course of the determining of the traffic density a speed of at least one of the further road-users that is delimiting a gap for the lane-change maneuver is determined, and the route of the planned lane-change maneuver is adapted as a function of the speed.

13. The method of claim 9, wherein the route of the planned lane-change maneuver is adapted to obtain minimal lateral dynamics during the lane-change maneuver when no further road-user is present in the destination lane within a predetermined distance from the vehicle.

14. The method of claim 9, wherein a check is made as to whether a driver of the vehicle has his/her hands on the steering wheel, and the route of the planned lane-change maneuver is additionally determined as a function of whether the driver has his/her hands on the steering wheel.

15. A lane-change assistance system for a vehicle, comprising a control unit configured to:
capture ambient-field data that describe an environment of the vehicle;
detect further road-users in the environment based on the ambient-field data;
plan a route of the lane-change maneuver from an initial lane into a destination lane, wherein lateral dynamics act on the vehicle during the lane-change maneuver;
determine a traffic density describing a number, a distribution, and/or a motion of the further road-users in the environment; and
adapt the planned route of the lane-change maneuver as a function of the determined traffic density to vary the lateral dynamics during the lane-change maneuver.

16. A vehicle including the lane-change assistance system of claim 15.
